(19) United States
(12) Patent Application Publication
(10) Pub. No.: US 2011/0181174 A1
(43) Pub. Date: Jul. 28, 2011

(54) PLASMA DISPLAY PANEL

(75) Inventors: Ryoji Hyuga, Osaka (JP); Hatsumi Komaki, Osaka (JP); Shingo Takagi, Osaka (JP); Tatsuo Mifune, Osaka (JP)

(73) Assignee: Matsushita Electric Industrial Co., Ltd., Osaka (JP)

(21) Appl. No.: 12/294,524

(22) PCT Filed: Mar. 25, 2008
(86) PCT No.: PCT/JP2008/000700

§ 371 Date: Sep. 25, 2008

(30) Foreign Application Priority Data
Apr. 18, 2007 (JP) 2007-108915
Apr. 18, 2007 (JP) 2007-108916

(51) Int. Cl. H01J 1/62

(52) U.S. Cl. 313/484

(57) ABSTRACT

A Plasma Display Panel includes a front panel and a rear panel. The front panel includes a display electrode and a dielectric layer on a glass substrate. The rear panel includes a barrier rib and a phosphor layer on a substrate. The front panel and the rear panel are arranged to face each other, and the peripheries thereof are sealed to form a discharge space therebetween. The display electrode is constituted of multiple layers including at least a metal electrode layer containing silver and a glass material. A content of bismuth oxide (Bi₂O₃) in the dielectric layer is in a range from 5% to 25% inclusive by weight, and a content of bismuth oxide (Bi₂O₃) in the glass material of the metal electrode layer is in range from 5% to 25% inclusive by weight.

### TECHNICAL FIELD

The present invention relates to a plasma display panel for use in a display device and the like.

### BACKGROUND ART

A plasma display panel (hereinafter, referred to as PDP) can achieve high definition and have a large screen. Accordingly, a televisions screen having a PDP approximately 100 inch in diagonal is commercially available. In recent years, with advancement of application of PDPs to high definition televisions with full specification having the number of scan lines at least twice as many as the known television compliant with the National Television System Committee (NTSC) system, PDPs containing no lead to address environmental issues have been required. In addition, in view of resource saving or reduction in material costs, less use of expensive rare metals is required.

The PDP basically includes a front panel and a rear panel. The front panel includes a glass substrate that is made of sodium borosilicate glass by means of a float method, display electrodes that have stripe-like transparent electrodes and bus electrodes formed on a principal surface of the glass substrate, a dielectric layer that covers the display electrodes and functions as a capacitor, and a protective layer that is made of magnesium oxide (MgO) formed on the dielectric layer. The rear panel includes a glass substrate, stripe-like address electrodes that are formed on a principal surface of the glass substrate, a base dielectric layer that covers the address electrodes, barrier ribs that are formed on the base dielectric layer, and phosphor layers that are formed between the barrier ribs and emit light in red, green, and blue.

The front panel and the rear panel are sealed airtight with the electrode-forming surfaces thereof facing each other. A Ne—Xe discharge gas is charged in a discharge space, which is partitioned by the barrier ribs, at a pressure ranging from 400 Torr to 600 Torr. In such a PDP, an image signal voltage is selectively applied to the display electrodes to make the display electrodes discharge. Then, ultraviolet light generated by the discharge excites the phosphor layers such that the phosphor layers emit light in red, green, and blue. In this way, color images are displayed.

Silver electrodes are used for the bus electrodes of the display electrodes in order to ensure conductivity. Low-melting glass essentially consisting of lead oxide is used for the dielectric layer. However, due to recent environmental issues, a lead-free dielectric layer is proposed (for example, see Patent Documents 1, 2, 3, and 4).

As the glass material for forming the electrodes, it is also proposed that bismuth oxide (Bi₂O₃) is included in a predetermined amount (for example, see Patent Document 5).

In recent years, PDPs are increasingly applied to the high definition television with full specification having the number of scan lines at least twice as many as the known NTSC system. Simultaneously, high brightness and improvement of contrast are achieved.

When the lead-free dielectric layer or the glass material for forming the electrode is used to address the environmental issues, black brightness may be deteriorated due to a black layer of the display electrode or a light-blocking layer. Accordingly, contrast may be lowered, and it may be not possible to ensure satisfactory image quality.

What is also required is resource saving or less use of expensive rare metals because of an increase in material costs. However, depending on the components of a black material of the black layer or the light-blocking layer, an increase in resistance (hereinafter, referred to as contact resistance) from a metal electrode serving as the bus electrode of the display electrode to the transparent electrode in a direction perpendicular to the substrate may be caused. The increase in resistance may be accompanied by an increase in power consumption, which may adversely affect image quality.

[Patent Document 1] Japanese Patent Unexamined Publication No. 2003-128430

[Patent Document 2] Japanese Patent Unexamined Publication No. 2002-053342

[Patent Document 3] Japanese Patent Unexamined Publication No. 2001-045877

[Patent Document 4] Japanese Patent Unexamined Publication No. 9-050769

[Patent Document 5] Japanese Patent Unexamined Publication No. 2000-048645

### DISCLOSURE OF THE INVENTION

A PDP according to the invention includes a front panel and a rear panel. The front panel includes a display electrode and a dielectric layer on a glass substrate. The rear panel includes an electrode, a barrier rib, and a phosphor layer on a substrate. The front panel and the rear panel are arranged to face each other, and peripheries thereof are sealed to form a discharge space therebetween. The display electrode is constituted of multiple layers including at least a metal electrode layer containing silver and a glass material. A content of bismuth oxide (Bi₂O₃) in the dielectric layer is in a range from 5% to 25% inclusive by weight, and a content of bismuth oxide (Bi₂O₃) in the glass material of the metal electrode layer is in a range from 5% to 25% inclusive by weight.

Such a structure can provide a PDP that achieves high image display quality and addresses environmental issues.

A black layer may include at least one of cobalt (Co), nickel (Ni), copper (Cu), cobalt (Co) oxide, nickel (Ni) oxide, and copper (Cu) oxide.

Such a structure can provide a PDP that achieves high image display quality and addresses environmental issues.

A PDP according to the invention includes a front panel and a rear panel. The front panel includes a display electrode, a light-blocking layer, and a dielectric layer on a glass substrate. The rear panel includes an electrode, a barrier rib, and a phosphor layer on a substrate. The front panel and the rear panel are arranged to face each other, and peripheries thereof are sealed to form a discharge space therebetween. The display electrode is constituted of multiple layers including at least a metal electrode layer containing silver and a glass material, and a black layer containing a black material and a glass material. The black layer includes at least one of cobalt (Co), nickel (Ni), copper (Cu), cobalt (Co) oxide, nickel (Ni) oxide, and copper (Cu) oxide. The content of bismuth oxide (Bi₂O₃) in the dielectric layer is in a range from 5% to 25% inclusive by weight.

### BRIEF DESCRIPTION OF THE DRAWINGS

FIG. 1 is a perspective view illustrating the structure of a PDP according to an embodiment of the invention.

FIG. 2 is a cross-sectional view illustrating the structure of a front panel in the PDP according to an embodiment of the invention.

FIG. 3 is a characteristic diagram illustrating black chroma of a light-blocking layer with respect to the content of bismuth oxide in a dielectric layer.

FIG. 4 is a characteristic diagram illustrating contact resistance with respect to components of a black electrode.

FIG. 5 is a characteristic diagram illustrating contact resistance with respect to the content of bismuth oxide in a dielectric layer.

FIG. 6 is a characteristic diagram illustrating contact resistance with respect to the content of bismuth oxide in a glass material of a white electrode.

### DESCRIPTION OF REFERENCE NUMERALS AND SIGNS

1: PDP

2: FRONT PANEL

3: FRONT GLASS SUBSTRATE

4: SCAN ELECTRODE

4a, 5a: TRANSPARENT ELECTRODE

4b, 5b: METAL BUS ELECTRODE

5: SUSTAIN ELECTRODE

6: DISPLAY ELECTRODE

7: LIGHT-BLOCKING LAYER

8: DIELECTRIC LAYER

9: PROTECTIVE LAYER

10: REAR PANEL

11: REAR GLASS SUBSTRATE

12: ADDRESS ELECTRODE

13: BASE DIELECTRIC LAYER

14: BARRIER RIB

15: PHOSPHOR LAYER

16: DISCHARGE SPACE

41b, 51b: BLACK ELECTRODE

42b, 52b: WHITE ELECTRODE

81: FIRST DIELECTRIC LAYER

82: SECOND DIELECTRIC LAYER

### PREFERRED EMBODIMENTS FOR CARRYING OUT THE INVENTION

A PDP according to an embodiment of the invention will now be described with reference to the drawings.

### Embodiment

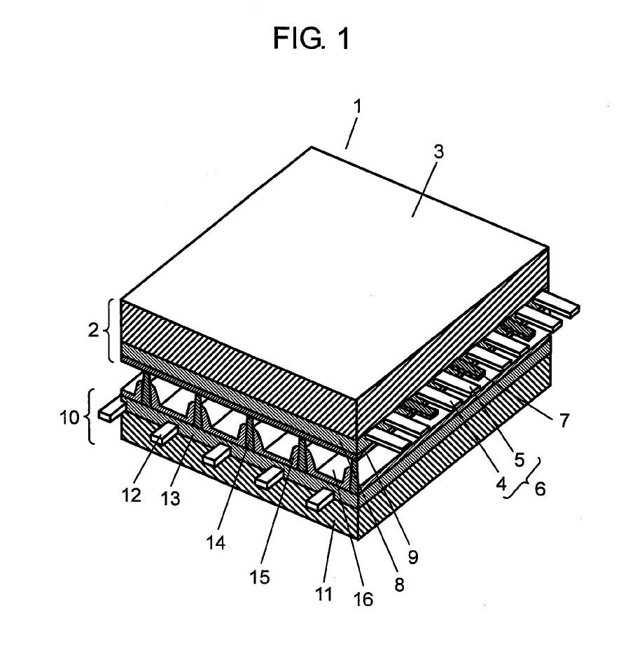

FIG. 1 is a perspective view illustrating the structure of a PDP according to an embodiment of the invention. The PDP is similar to a general AC surface discharge type PDP. As shown in FIG. 1, PDP 1 includes front panel 2 made of front glass substrate 3 or the like, and rear panel 10 made of rear glass substrate 11 or the like. Front panel 2 and rear panel 10 are arranged to face each other, and the outer peripheries thereof are sealed airtight by a sealing material made of glass frits. Discharge space 16 in sealed PDP 1 is charged with a discharge gas including Ne and Xe at a pressure ranging from 400 Torr to 600 Torr.

On front glass substrate 3 of front panel 2, a plurality of rows of display electrodes 6, each including a pair of stripe-like scan electrode 4 and sustain electrode 5, and light-blocking layers 7 are disposed in parallel with each other. On front glass substrate 3, dielectric layer 8 is formed to cover display electrodes 6 and light-blocking layers 7. Dielectric layer 8 functions as a capacitor. Further, on the surface of the dielectric layer, protective layer 9 made of magnesium oxide (MgO) or the like is formed.

On rear glass substrate 11 of rear panel 10, a plurality of stripe-like address electrodes 12 are disposed in parallel with each other in a direction perpendicular to scan electrode 4 and sustain electrode 5 of front panel 2. Base dielectric layer 13 coats the address electrodes 12. On base dielectric layer 13 between address electrodes 12, barrier ribs 14 having a predetermined height are formed to partition discharge space 16. Phosphor layers 15 are sequentially applied to the grooves between barrier ribs 14 such that ultraviolet light excites the phosphor layers 15 to emit light in red, blue, and green for each address electrode 12. Discharge cells are formed at intersections of scan electrodes 4 and sustain electrodes 5, and address electrodes 12. The discharge cells that include phosphor layers 15 in red, blue, and green and are arranged in the direction of display electrodes 6 to form pixels for color displays.

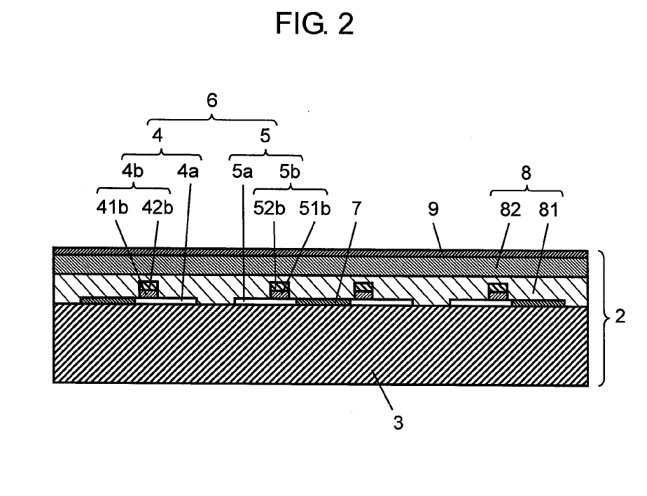

FIG. 2 is a cross-sectional view illustrating the structure of front panel 2 in the PDP according to the embodiment of the invention. FIG. 2 shows a vertically inverted view of FIG. 1. As shown in FIG. 2, display electrodes 6, each including scan electrode 4 and sustain electrode 5, and light-blocking layers 7 are patterned on front glass substrate 3 manufactured by means of a float method. Scan electrode 4 and sustain electrodes 5 include transparent electrodes 4a and 5a made of indium tin oxide (ITO) or tin oxide (SnO₂), and metal bus electrodes 4b and 5b formed on transparent electrodes 4a and 5a, respectively. Metal bus electrodes 4b and 5b are used to impart conductivity to transparent electrodes 4a and 5a in a longitudinal direction thereof, and made of a conductive material essentially consisting of a silver (Ag) material. Metal bus electrodes 4b and 5b include black electrodes 41b and 51b and white electrodes 42b and 52b, respectively.

Dielectric layer 8 is constituted of at least two layers: first dielectric layer 81 that is provided to cover transparent electrodes 4a and 5a and metal bus electrodes 4b and 5b, and light-blocking layers 7 formed on front glass substrate 3; and second dielectric layer 82 that is formed on first dielectric layer 81. Protective layer 9 is formed on second dielectric layer 82.

Next, a method of manufacturing a PDP will be described. First, scan electrodes 4, sustain electrodes 5, and light-blocking layers 7 are formed on front glass substrate 3. Transparent electrodes 4a and 5a and metal bus electrodes 4b and 5b are patterned by means of a photolithography method or the like. Transparent electrodes 4a and 5a are formed by means of a thin film process or the like. Metal bus electrodes 4b and 5b are solidified by firing a paste containing conductive black particles or a silver (Ag) material at a predetermined temperature. Light-blocking layers 7 are similarly formed. For example, a paste containing a black material is screen-printed or a black material is formed on the entire surface of the glass substrate, patterned by means of a photolithography method, and fired.

Generally, a sequence for forming metal bus electrodes 4b and 5b is as follows. A paste containing a black material is printed on front glass substrate 3 and dried, and patterned by means of a photolithography method to thereby form light-blocking layers 7. On light-blocking layers 7, a paste containing a pigment and a paste containing conductive particles are repeatedly printed and dried. Thereafter, the pastes are patterned by means of a photolithography method to thereby form metal bus electrodes 4b and 5b including black electrodes 41b and 51b and white electrodes 42b and 52b, respectively. At this time, in order to improve contrast at the time of image display, black electrodes 41b and 51b are formed in a lower layer (on front glass substrate 3 side), and white electrodes 42b and 52b are formed in an upper layer.

In the embodiment of the invention, black electrodes 41b and 51b of metal bus electrodes 4b and 5b and light-blocking layers 7 are formed by using the same material in the same process. The invention relates to a technology for improving black chroma. Accordingly, in the embodiment of the invention, black chroma of light-blocking layers 7 can also be improved, and the advantage of the invention can be dynamized.

Next, a dielectric paste is applied to front glass substrate 3 to cover scan electrodes 4, sustain electrodes 5, and light-blocking layers 7 by a die coat method or the like, to form a dielectric paste layer (dielectric glass layer). Leaving the dielectric paste after application for a predetermined time levels the surface of the applied dielectric paste and provides a flat surface. Thereafter, the dielectric paste layer is fired and solidified to form dielectric layer 8 which covers scan electrodes 4, sustain electrodes 5, and light-blocking layers 7. In the embodiment of the invention, the dielectric layer is repeatedly applied to form two-layered dielectric layer 8 including first dielectric layer 81 and second dielectric layer 82. The dielectric paste is a paint containing a dielectric glass powder, a binder, and a solvent.

Next, protective layer 9 made of magnesium oxide (MgO) is formed on dielectric layer 8 by means of a vacuum deposition method. In this way, predetermined constituent members are formed on front glass substrate 3. Thus, front panel 2 is completed.

Rear panel 10 is formed in the following process. First, a paste containing a silver (Ag) material is screen-printed on rear glass substrate 11, or a metal film is formed on the entire surface of rear glass substrate 11 and patterned by means of a photolithography method, to thereby form a material layer to be a structure for address electrodes 12. Then, the material layer is fired at a predetermined temperature, to thereby form address electrodes 12. Next, on rear glass substrate 11 having address electrodes 12 formed thereon, a dielectric paste is applied to cover address electrodes 12 by means of a die coat method or the like. Thereafter, the dielectric paste layer is fired, to thereby form base dielectric layer 13. The dielectric paste is a paint containing a dielectric glass powder, a binder, and a solvent.

Next, a paste for forming barrier ribs containing a barrier rib material is applied to base dielectric layer 13 and patterned in a predetermined shape, to thereby form a barrier rib material layer. Thereafter, the barrier rib material layer is fired to form barrier ribs 14. Usable methods of patterning the paste for barrier ribs applied to base dielectric layer 13 include a photolithography method and a sandblast method. Next, a phosphor paste containing a phosphor material is applied to base dielectric layer 13 between adjacent barrier ribs 14 and the side surfaces of barrier ribs 14 and fired, to thereby form phosphor layers 15. In this way, predetermined constituent members are formed on rear glass substrate 11. Thus, rear panel 10 is completed.

Front panel 2 and rear panel 10 including predetermined constituent members manufactured as above are arranged to face each other such that scan electrodes 4 are orthogonal to address electrodes 12. Then, the peripheries of the panels are sealed with glass frits, and a discharge gas including Ne and Xe is charged into discharge space 16. Thus, PDP 1 is completed.

Next, display electrodes 6 and dielectric layer 8 of front panel 2 will be described in detail. First, display electrodes 6 will be described. Indium tin oxide (ITO) having a thickness of approximately 0.12 μm is formed on the entire surface of front glass substrate 3 by means of a sputtering method. Thereafter, stripe-like transparent electrodes 4a are 5a having a width of 150 μm are formed by means of a photolithography method.

Then, a photosensitive paste is applied to the entire surface of front glass substrate 3 by means of a print method or the like, to thereby form a black electrode paste layer as a black layer. The photosensitive paste to be the black layer contains 5% to 40% inclusive by weight of a black material including at least one of cobalt (Co) black metal fine particles, nickel (Ni) black metal fine particles, copper (Cu) black metal fine particles, cobalt (Co) metal oxide, nickel (Ni) metal oxide, copper (Cu) metal oxide, cobalt (Co) metal composite oxide, nickel (Ni) metal composite oxide, and copper (Cu) metal composite oxide, 10% to 40% inclusive by weight of the glass material, and 30% to 60% inclusive by weight of photosensitive organic binder components containing photosensitive polymer, a photosensitive monomer, a photopolymerization initiator, a solvent, and the like. That is, each of display electrodes 6 is constituted of multiple layers including at least a metal electrode layer containing silver and a glass material, and the black layer containing a black material and a glass material.

The glass material of the black electrode paste layer at least contains 5% to 25% inclusive by weight of bismuth oxide (Bi₂O₃). The softening point of the glass material is set to be higher than 500° C. Cobalt (Co) black metal fine particles, metal oxide, or metal composite oxide, nickel (Ni) black metal fine particles, metal oxide, or metal composite oxide, and copper (Cu) black metal fine particles, metal oxide, or metal composite oxide as the black material also partially function a conductive material.

A photosensitive paste is applied to the black electrode paste layer by means of a print method, to thereby form a white electrode paste layer. The photosensitive paste at least contains 70% to 90% inclusive by weight of silver (Ag) particles, 1% to 15% inclusive by weight of a glass material, and 8% to 30% inclusive by weight of photosensitive organic binder components containing a photosensitive polymer, a photosensitive monomer, a photopolymerization initiator, a solvent, and the like. The glass material of the white electrode paste layer at least contains 5% to 25% inclusive by weight of bismuth oxide (Bi₂O₃). The softening point of the glass material is set to be higher than 550° C.

The black electrode paste layer and the white electrode paste layer applied to the entire surface of the front glass substrate are patterned by using a photolithography method. Then, the patterned black electrode paste layer and the white electrode paste layer are fired at a temperature ranging from 550° C. to 600° C. Thus, black electrodes 41b and 51b and white electrodes 42b and 52b having line widths of approximately 60 μm are formed on transparent electrodes 4a and 5a.

As such, in the embodiment of the invention, at least one of cobalt (Co), nickel (Ni), and copper (Cu) is used for black electrodes 41b and 51b. Meanwhile, in the related art, both of black electrodes 41b and 51b and light-blocking layers 7 contain chromium (Cr), manganese (Mn), andiron (Fe), thereby ensuring conductivity and black chroma. However, the inventors have found that the use of chromium (Cr), manganese (Mn), and iron (Fe) for black electrode 41b and 51b causes an increase in contact resistance at interfaces between black electrodes 41b and 51b and white electrodes 42b and 52b, and then resistance of the entire electrode layer tends to be increased. Further, it has been found that this tendency depends on the components of the glass material in black electrodes 41b and 51b or the components of dielectric layer 8.

This phenomenon will be described below. Usually, a heat treatment at the time of firing electrodes or dielectric makes silver (Ag) particles included in white electrodes 42b and 52b come into contact with each other, and then the electrodes develop conductivity. However, the conductive material or the black material included in black electrodes 41b and 51b is moved to and diffused into white electrodes 42b and 52b at the time of firing the electrodes or dielectric, and prevents the silver (Ag) particles from coming into contact with each other. In contrast, when at least one of cobalt (Co), nickel (Ni), and copper (Cu) is used for black electrodes 41b and 51b, the diffusion of components of such as the conductive material or the black material included in black electrodes 41b and 51b into white electrodes 42b and 52b is suppressed. As a result, there is no case where the conductive material or the black material prevents the silver (Ag) particles from coming into contact with each other. Therefore, it would appear that it is possible to reduce contact resistance at the interfaces between black electrodes 41b and 51b and white electrodes 42b and 52b.

Meanwhile, if the black electrodes contain the components of chromium (Cr), manganese (Mn), and iron (Fe) as the black material or the conductive material, the components of such as the conductive material or the black material included in black electrodes 41b and 51b are diffused into white electrodes 42b and 52b at the time of firing. Then, the diffused components prevent the silver (Ag) particles from coming into contact with each other, and as a result, contact resistance at the interfaces is increased.

The related art also discloses that black electrodes 41b and 51b or light-blocking layers 7 contain ruthenium (Ru), thereby ensuring black chroma and conductivity. However, ruthenium (Ru) is an expensive rare metal, and use of ruthenium (Ru) causes an increase in material costs. Such an increase in partial material costs largely affects on a PDP having a large screen. Accordingly, in the embodiment of the invention, ruthenium (Ru) is not substantially used, and in terms of reduction in material costs or resource saving, superior advantages are obtained, as compared with the related art.

As described above, in the glass material used for black electrodes 41b and 51b and white electrodes 42b and 52b, the content of bismuth oxide (Bi₂O₃) is in a range from 5% to 25% inclusive by weight. Preferably, the glass material contains from 0.1% to 7% inclusive by weight of at least one of molybdenum oxide (MoO₃) and tungstic oxide (WO₃). In place of molybdenum oxide (MoO₃) and tungstic oxide (WO₃), the glass material may include 0.1% to 7% inclusive by weight of at least one of cerium oxide (CeO₂), copper oxide (CuO), cobalt oxide (Co₂O₃), vanadium oxide (V₂O₇), and antimony oxide (Sb₂O₃).

In addition to the above components, the glass material may lead-free components, for example, 0% to 40% inclusive by weight of zinc oxide (ZnO), 0% to 35% inclusive by weight of boron oxide (B₂O₃), 0% to 15% inclusive by weight of silicon oxide (SiO₂), 0% to 10% inclusive by weight of aluminum oxide (Al₂O₃), and the like. The contents of these components are not particularly limited, and are within the range of the contents in the related art.

In the invention, the softening point of the glass material is set to 500° C. or higher, and the firing temperature is in a range from 550° C. to 600° C. Like the related art, when the softening point of the glass material is low, for example, in a range from 450° C. to 500° C., the firing temperature becomes higher than the softening point of the glass material by approximately 100° C. In this case, reactive bismuth oxide (Bi₂O₃) vigorously reacts with silver (Ag) particles, black metal fine particles, or the organic binder component in the paste. As a result, air bubbles are generated in metal bus electrodes 4b and 5b and dielectric layer 8, and dielectric strength of dielectric layer 8 is deteriorated. Meanwhile, like the invention, if the softening point of the glass material is set to 500° C. or higher, bismuth oxide (Bi₂O₃) rarely reacts with silver (Ag) particles, black metal fine particles, or organic components, and little air bubbles are generated. If the softening point of the glass material is set to 600° C. or higher, undesirably, adhesiveness of metal bus electrodes 4b and 5b and transparent electrodes 4a and 5a, front glass substrate 3, or dielectric layer 8 is degraded.

Next, first dielectric layer 81 and second dielectric layer 82 constituting dielectric layer 8 of front panel 2 will be described. The dielectric material for first dielectric layer 81 has the following composition. That is, the dielectric material contains 5% to 25% inclusive by weight of bismuth oxide (Bi₂O₃) and 0.5% to 15% inclusive by weight of calcium oxide (CaO). Further, the dielectric material includes 0.1% to 7% inclusive by weight of at least one of molybdenum oxide (MoO₃), tungstic oxide (WO₃), cerium oxide (CeO₂), and manganese oxide (MnO₂).

The dielectric material also includes 0.5% to 12% inclusive by weight of at least one of strontium oxide (SrO) and barium oxide (BaO).

In place of molybdenum oxide (MoO₃), tungstic oxide (WO₃), cerium oxide (CeO₂), and manganese oxide (MnO₂), the dielectric material may include 0.1% to 7% inclusive by weight of at least one of copper oxide (CuO), chromium oxide (Cr₂O₃), cobalt oxide (Co₂O₃), vanadium oxide (V₂O₇), and antimony oxide (Sb₂O₃).

In addition to the above components, the dielectric material may contain lead-free components, for example, 0% to 40% inclusive by weight of zinc oxide (ZnO), 0% to 35% inclusive by weight of boron oxide (B₂O₃), 0% to 15% inclusive by weight of silicon oxide (SiO₂), 0% to 10% inclusive by weight of aluminum oxide (Al₂O₃), and the like. The contents of these components are not particularly limited, and are within the range of the contents in the related art.

The dielectric material having the above components is pulverized with a wet jet mill or a ball mill to have an average particle size ranging from 0.5 μm to 2.5 μm, to thereby provide a dielectric material powder. Next, 55% to 70% inclusive by weight of the dielectric material powder and 30% to 45% inclusive by weight of binder components are sufficiently kneaded with a three-roll kneader, to thereby provide a first dielectric layer paste for die coat or printing.

Then, the paste for the first dielectric layer is printed on front glass substrate 3 to cover display electrodes 6 by means of a die coat method or a screen print method, and dried. Thereafter, the paste is fired at a temperature ranging from 575° C. to 590° C., slightly higher than the softening point of the dielectric material.

Next, second dielectric layer 82 will be described. The dielectric material for second dielectric layer 82 has the following composition. That is, the dielectric material contains 5% to 25% inclusive by weight of bismuth oxide (Bi₂O₃) and 6.0% to 28% inclusive by weight of barium oxide (BaO). Further, the dielectric material includes 0.1% to 7% inclusive by weight of at least one of molybdenum oxide (MoO₃), tungstic oxide (WO₃), cerium oxide (CeO₂), and manganese oxide (MnO₂).

The dielectric material also includes 0.8% to 17% inclusive by weight of at least one of calcium oxide (CaO) and strontium oxide (SrO).

In place of molybdenum trioxide (MoO₃), tungstic oxide (WO₃), cerium oxide (CeO₂), and manganese oxide (MnO₂), the dielectric material may include 0.1% to 7% inclusive by weight of at least one of copper oxide (CuO), chromium oxide (Cr₂O₃), cobalt oxide (Co₂O₃), vanadium oxide (V₂O₇), and antimony oxide (Sb₂O₃).

In addition to the above components, the dielectric material may contain lead-free components, for example, 0% to 40% inclusive by weight of zinc oxide (ZnO), 0 to 35% inclusive by weight of boron oxide (B₂O₃), 0% to 15% inclusive by weight of silicon oxide (SiO₂), 0% to 10% inclusive by weight of aluminum oxide (Al₂O₃), and the like. The contents of these components are not particularly limited, and are within the range of the contents in the related art.

The dielectric material having the above components is pulverized with a wet jet mill or a ball mill to have an average particle size ranging from 0.5 μm to 2.5 μm, to thereby provide a dielectric material powder. Next, 55% to 70% inclusive by weight of the dielectric material powder and 30% to 45% inclusive by weight of binder components are sufficiently kneaded with a three-roll kneader, to thereby provide a second dielectric layer paste for die coat or printing. Then, the paste for the second dielectric layer is printed on first dielectric layer 81 by a screen print method or a die coat method, and dried. Thereafter, the paste is fired at a temperature ranging from 550° C. to 590° C., slightly higher than the softening point of the dielectric material.

The advantage of improvement of the panel brightness and reduction of the discharge voltage is more distinct at the smaller thickness of dielectric layer 8. Accordingly, it is desirable to set the thickness as small as possible insofar as the dielectric strength is not degraded. In terms of such a condition and visible-light transmittance, in the embodiment of the invention, the thickness of dielectric layer 8 is not more than 41 μm, with that of first dielectric layer 81 ranging from 5 μm to 15 μm and that of second dielectric layer 82 ranging from 20 μm to 36 μm.

In the invention, the content of bismuth oxide (Bi₂O₃) in dielectric layer 8 is in a range from 5% to 25% inclusive by weight for first dielectric layer 81 and second dielectric layer 82. The content of bismuth oxide (Bi₂O₃) in dielectric layer 8 within this range ensures improvement of black chroma in the PDP, and a predetermined softening point and a dielectric constant as dielectric layer 8. It is not necessary to set the contents of bismuth oxide (Bi₂O₃) in first dielectric layer 81 and second dielectric layer 82 to be the same.

The front panel manufactured in such a manner has good black chroma and is provided with the metal electrode having low contact resistance. When the front panel is used as a panel for a PDP, it is possible to obtain a PDP having good contrast at the time of image display.

### EXAMPLES

In order to confirm the advantages in the embodiment of the invention, test samples of a front panel suitable for a high definition television approximately 42 inch in diagonal are fabricated and their performances are evaluated.

For evaluation of the black chroma, samples are fabricated in which light-blocking layers 7 are formed on the glass substrate by means of the above method, and dielectric layer 8 is formed to cover light-blocking layers 7 by means of the above method, and their performances are evaluated.

Generally, lightness L* is calculated by means of the method defined in JIS Z8722 (Color Measurement Method) and JIS Z8729 (Color Display Method—L*a*b* Colorimetric System and L*u*v* calorimetric System). In the embodiment of the invention, the black chroma is expressed by using the L*a*b* colorimetric system, and a low L* value is defined to represent high (good) black chroma. Then, when the L* value is low, at the time of image display in the PDP, contrast is increased. In the embodiment of the invention, the L* value is measured with a spectrophotometer (Model No. NF 999, manufactured by Nippon Denshoku).

The samples to be measured are patterned by means of the same method as described above such that a measurement area becomes 10 mm square. The measurement is carried out from the glass substrate side (image display side) after a white panel is superimposed on the film surface. The measurement is carried out at three different points in the substrate approximately 42 inch in diagonal, and as the measurement result, the average of the measurement values at three points is calculated.

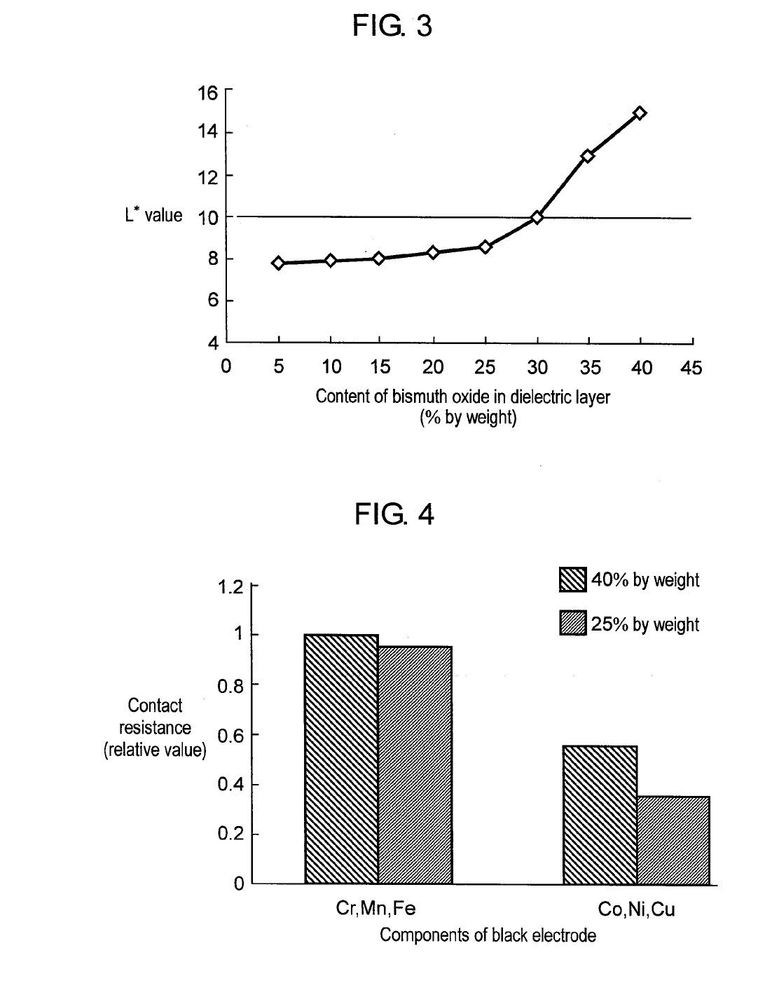

FIG. 3 is a diagram illustrating a change in the black chroma, that is, the L* value, of light-blocking layer 7 with respect to the content of bismuth oxide (Bi₂O₃) in dielectric layer 8. On the measurement conditions set by the inventors, at the time of image display in the PDP, if the L* value of light-blocking layer 7 is not more than 10, good contrast is obtained. From this, as shown in FIG. 3, for the samples having the L* value not more than 10, the content of bismuth oxide (Bi₂O₃) in dielectric layer 8 is in a range from 5% to 30% inclusive by weight.

Although the reason of occurrence of this phenomenon has not been known in detail, the inventors have considered that the phenomenon is caused by the influence of bismuth oxide (Bi₂O₃) in dielectric layer 8 (in the embodiment of the invention, particularly, first dielectric layer 81) on a rear surface of light-blocking layer 7 on the display side or near the ends of black electrodes 41b and 51b. It has been supposed that this influence makes cobalt (Co) black metal fine particles, metal oxide, or metal composite oxide, nickel (Ni) black metal fine particles, metal oxide, or metal composite oxide, or copper (Cu) black metal fine particles, metal oxide, or metal composite oxide as the black material to be diffused toward front glass substrate 3, that is, the image display surface, whereby black chroma is improved.

Next, studies on contact resistance of display electrodes 6 will be described. For evaluation of contact resistance of display electrodes 6, transparent electrodes 4a and 5a, black electrodes 41b and 51b, and white electrodes 42b and 52b are formed on the glass substrate by means of the above method. Further, dielectric layer 8 is formed to cover these electrodes by means of the above method. Thus, test samples are fabricated. Then, the performance is evaluated by measuring resistance of the test samples with a tester. For the samples, in order to avoid contact resistance of a dielectric itself, terminals are formed so as to eliminate the influence of contact resistance of dielectric layer 8.

FIG. 4 is a diagram illustrating a characteristic difference of contact resistance with respect to the components of black electrodes 41b and 51b. Here, comparison of contact resistance with samples in which the content of bismuth oxide (Bi₂O₃) in dielectric layer 8 is 25% inclusive by weight and 40% inclusive by weight is carried out. The contact resistance is shown as a relative value when the measurement result of a sample in which the content of bismuth oxide (Bi₂O₃) in dielectric layer 8 is 40% inclusive by weight and black electrodes 41b and 51b contain chromium (Cr), manganese (Mn), and iron (Fe) is supposed to be 1.

As a result, it can be seen that, when black electrodes 41b and 51b contains cobalt (Co), nickel (Ni), and copper (Cu) used in the embodiment of the invention, contact resistance is further reduced, as compared with a case where black electrodes 41b and 51b contain chromium (Cr), manganese (Mn), and iron (Fe). This is because, when black electrodes 41b and 51b contain cobalt (Co), nickel (Ni), and copper (Cu), the diffusion of the conductive material or the black material included in black electrodes 41b and 51b into the electrode layer is suppressed, and accordingly the conductive material or the black material does not prevent silver (Ag) particles from coming into contact with each other.

The contact resistance depends on the content of bismuth oxide (Bi₂O₃) in dielectric layer 8. As shown in FIG. 4, for a sample in which the content of bismuth oxide (Bi₂O₃) is 25% inclusive by weight, the contact resistance is lowered.

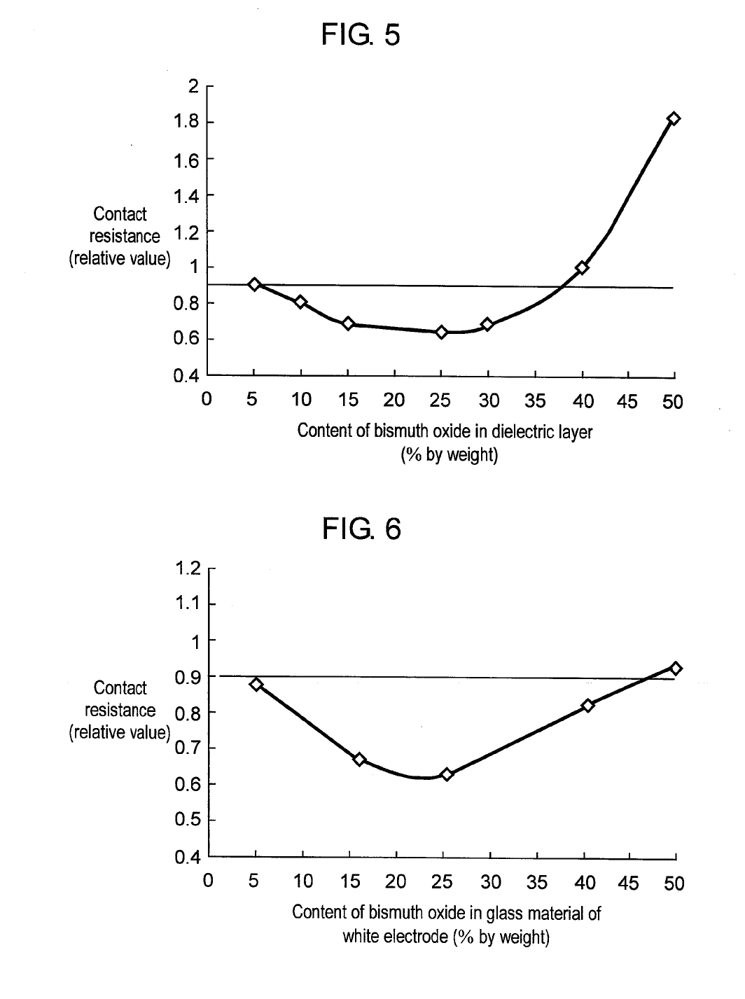

In the embodiment of the invention, a change in contact resistance with respect to the content of bismuth oxide (Bi₂O₃) in the glass material of white electrodes 42b and 52b, and the content of bismuth oxide (Bi₂O₃) in dielectric layer 8 is also examined. This result is shown in FIGS. 5 and 6. FIG. 5 is a diagram illustrating a change in contact resistance with respect to the content of bismuth oxide (Bi₂O₃) in dielectric layer 8 when the content of bismuth oxide (Bi₂O₃) in the glass material of white electrodes 42b and 52b is 25% inclusive by weight. FIG. 6 is a diagram illustrating a change in contact resistance with respect to the content of bismuth oxide (Bi₂O₃) in the glass material of white electrodes 42b and 52b when the content of bismuth oxide (Bi₂O₃) in dielectric layer 8 is 25% inclusive by weight. Similarly to FIG. 4, the contact resistance is shown as a relative value when the measurement result of a sample in which the content of bismuth oxide (Bi₂O₃) in dielectric layer 8 is 40% inclusive by weight and black electrodes 41b and 51b contain chromium (Cr), manganese (Mn), and iron (Fe) is supposed to be 1.

In the embodiment of the invention, if the contact resistance is not more than 0.9 as the relative value, the amount of an increase in resistance of the entire display electrode is small, and the influence on a voltage required for image display is suppressed small. As shown in FIG. 5, the contact resistance of not more than 0.9 is obtained when the content of bismuth oxide (Bi₂O₃) in dielectric layer 8 is in a range from 5% to 30% inclusive by weight. Meanwhile, in terms of reactive power during discharge, dielectric layer 8 is required to have a low dielectric constant. Accordingly, preferably, the content of bismuth oxide (Bi₂O₃) in dielectric layer 8 is not more than 25% inclusive by weight. Therefore, preferably, the content of bismuth oxide (Bi₂O₃) in dielectric layer 8 is in a range from 5% to 25% inclusive by weight.

As shown in FIG. 6, the contact resistance of not more than 0.9 is obtained when the content of bismuth oxide (Bi₂O₃) in white electrodes 42b and 52b is in a range from 5% to 40% inclusive by weight. Meanwhile, in terms of the softening point at the time of firing, preferably, the content of bismuth oxide (Bi₂O₃) in white electrodes 42b and 52b is not more than 25% inclusive by weight. Therefore, preferably, the content of bismuth oxide (Bi₂O₃) in the glass material of the metal electrode layer is in a range from 5% to 25% inclusive by weight.

As described above, in the embodiment of the invention, a PDP includes a front panel and a rear panel. The front panel includes, on a glass substrate, display electrodes and a dielectric layer. The rear panel includes, on a substrate, electrodes, barrier ribs, and phosphor layers. The front panel and the rear panel are arranged to face each other, and the peripheries thereof are sealed to form a discharge space. Each of the display electrodes is constituted of multiple layers including at least a metal electrode layer containing silver and a glass material. The content of bismuth oxide (Bi₂O₃) in the dielectric layer is in a range from 5% to 25% inclusive by weight, and the content of bismuth oxide (Bi₂O₃) in the glass material of the metal electrode layer is in a range from 5% to 25% inclusive by weight. A black layer may include at least one of cobalt (Co), nickel (Ni), copper (Cu), cobalt (Co) oxide, nickel (Ni) oxide, and copper (Cu) oxide. Therefore, the contact resistance of the display electrodes can be reduced, and as a result, it is possible to provide a PDP having good black chroma and high image display quality. In addition, the PDP according to the embodiment of the invention can reduce material costs and can be lead (Pb)-free to address environmental issues.

As described above, in the embodiment of the invention, a PDP includes a front panel and a rear panel. The front panel includes, on a glass substrate, display electrodes, light-blocking layers, and a dielectric layer. The rear panel include, on a substrate, electrodes, barrier ribs, and phosphor layers. The front panel and the rear panel are arranged to face each other, and the peripheries thereof are sealed to form a discharge space. Each of the display electrodes is constituted of multiple layers including at least a metal electrode layer containing silver and a glass material, and a black layer containing a black material and a glass material. The black layer includes at least one of cobalt (Co), nickel (Ni), copper (Cu), cobalt (Co) oxide, nickel (Ni) oxide, and copper (Cu) oxide. The content of bismuth oxide (Bi₂O₃) in the dielectric layer may be in a range from 5% to 25% inclusive by weight. Therefore, the contact resistance of the display electrodes can be reduced, and as a result, it is possible to provide a PDP having good black chroma and high image display quality.

### INDUSTRIAL APPLICABILITY

As described above, according to the embodiment of the invention, it is possible to provide a PDP that achieves good contrast during image display and addresses environmental issues. In addition, the invention can be applied to a display device having a large screen.

1. A plasma display panel, comprising:
a front panel including a display electrode and a dielectric layer on a glass substrate; and
a rear panel including an electrode, a barrier rib and a phosphor layer on a substrate,
wherein the front panel and the rear panel are arranged to face each other, and peripheries thereof are sealed to form a discharge space,
the display electrode is constituted of multiple layers including at least a metal electrode layer containing silver and a glass material, and
a content of bismuth oxide in the dielectric layer is in a range from 5% to 25% inclusive by weight, and a content of bismuth oxide in the glass material of the metal electrode layer is in a range from 5% to 25% inclusive by weight.

2. The plasma display panel of claim 1,
wherein the display electrode includes a black layer containing a black material and a glass material, and
the black layer includes at least one of cobalt, nickel, copper, cobalt oxide, nickel oxide, and copper oxide.

3. A plasma display panel, comprising:
a front panel including a display electrode, a light-blocking layer, and a dielectric layer on a glass substrate;
a rear panel including an electrode, a barrier rib and a phosphor layer on a substrate,
wherein the front panel and the rear panel are arranged to face each other, and peripheries thereof are sealed to form a discharge space,
the display electrode is constituted of multiple layers including at least a metal electrode layer containing silver and a glass material, and a black layer containing a black material and a glass material,
the black layer includes at least one of cobalt, nickel, copper, cobalt oxide, nickel oxide, and copper oxide, and
a content of bismuth oxide in the dielectric layer is in a range from 5% to 25% inclusive by weight.
